(19) United States
(12) Patent Application Publication
(10) Pub. No.: US 2008/0205722 A1
(43) Pub. Date: Aug. 28, 2008

(54) Method and Apparatus for Automatic 4D Coronary Modeling and Motion Vector Field Estimation

(75) Inventors: Dirk Schaefer, Hamburg (DE); Michael Grass, Buchholz in der Nordheide (DE); Uwe Jandt, Hamburg (DE)

Correspondence Address: PHILIPS INTELLECTUAL PROPERTY & STANDARDS, 595 MINER ROAD, CLEVELAND, OH, 44143, US

(73) Assignee: Koninklijke Phillips Electronics N.V., Eindhoven (NL)

(21) Appl. No.: 12/063,682

(22) PCT Filed: Aug. 4, 2006
(86) PCT No.: PCT/IB2006/052705

§ 371 Date: Feb. 13, 2008

Related U.S. Application Data
(60) Provisional application No. 60/708,954, filed on Aug. 17, 2005.

(51) Int. Cl. G06K 9/00

(52) U.S. Cl. 382/128

(57) ABSTRACT

A method for computer-aided four-dimensional (4D) modeling of an anatomical object comprises acquiring a set of three-dimensional (3D) models representing a plurality of static states of the object throughout a cycle. A 4D correspondency estimation is performed on the set of 3D models to determine which points of the 3D models most likely correspond to each other, wherein the 4D correspondency estimation includes one or more of (i) defining a reference phase, (ii) performing vessel-oriented correspondency estimation, and (iii) post-processing of 4D motion data. The method further comprises automatic 3D modeling with a front propagation algorithm.

The present embodiments relate generally to computer-aided reconstruction of a three-dimensional anatomical object from diagnostic image data and more particularly, to a method and apparatus for automatic 4D coronary modeling and motion vector field estimation.

Coronary arteries can be imaged with interventional X-ray systems after injection of contrast agent. Due to coronary motion, the generation of three-dimensional (3D) reconstructions from a set of two-dimensional (2D) projections is only possible using a limited number of projections belonging to the same cardiac phase, which results in very poor image quality. Accordingly, methods have been developed to derive a 3D model of the coronary tree from two or more projections. Some of the methods are based on an initial 2D centreline in one of the X-ray angiograms and the search for corresponding centreline points in other angiograms of the same cardiac phase, exploiting epipolar constraints. As a result, the algorithms are very sensitive to respiratory and other residual non-periodic motion.

Another method is based on a front propagation algorithm in 3D. In the later method, a speed function, for controlling the front propagation, is defined by the probability that a boundary voxel of the front belongs to a vessel. The probability is evaluated by forward projecting the voxel into every vesselness-filtered projection of the same cardiac phase and multiplying the response values. It is noted that such an algorithm is less sensitive to residual motion inconsistencies between different angiograms. However, such a front propagation algorithm in 3D is only semi-automatic.

For example, the 3D seed point, which is the starting point of the front propagation, has to be defined manually. The 3D end point for each vessel has to be defined manually. From end point to seed point, the 3D front propagation algorithm searches automatically the fastest connecting path with respect to the speed function. In one aspect of the 3D front propagation algorithm, an end point is derived from the considered size of the reconstruction volume. However, this is very unspecific criteria causing the algorithm to miss vessel-branches if set too small; or the front propagates beyond the borders of the vessel tree volume if the value is set too high. It is likely that in most cases, there is not a single value of the criteria avoiding the above-mentioned artifacts for the whole vessel tree. A much more specific criterion, optimized for each vessel, is needed.

In addition, with respect to the 3D front propagation algorithm, the search and ranking of different vessels and vessel-segments according to their relevance is referred to as “structuring.” In a workflow of the 3D front propagation algorithm, a user performs a ranking by manually selecting specific vessels and manually defining the seed point and the end points for every vessel, thus manually attaining the “structuring.”

Furthermore, the 3D front propagation algorithm extracts coronary models and centerlines for single cardiac phases, only. In order to derive a four-dimensional (4D) motion field from a set of models or center lines from different cardiac phases, a method must be given to derive corresponding points on the 3D centerlines.

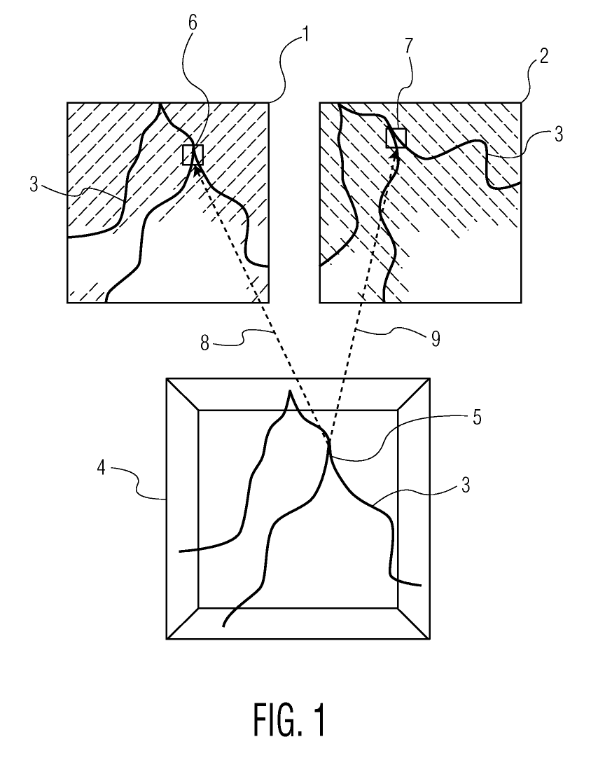

FIG. 1 shows schematically a diagnostic projection data set consisting of two (2) two-dimensional (2D) projections 1 and 2 which were acquired by means of X-ray fluoroscopy in the same cardiac phase. Note that any suitable type of cardiac phase monitoring can be used, for example, the recording of an electrocardiogram (ECG) in parallel with acquisition of the X-ray projections. Each of the projections 1 and 2, recorded at different projection angles, shows a branched blood vessel 3 of a patient. The projection images 1 and 2 accordingly show the same blood vessel 3 from different perspectives. To acquire the projection data set, a contrast agent was administered to the patient, such that the blood vessel 3 shows up dark in the projections.

To reconstruct the three-dimensional structure of the blood vessel 3 according to the 3D front propagation method, a seed point 5 is initially set within a reconstruction volume 4. The blood vessel 3 is then reconstructed in the volume 4, by locating adjacent points in the volume 4 in each case belonging to the blood vessel 3 in accordance with a propagation criterion. To this end, local areas 6 and 7 belonging to the respective point 5 within the two-dimensional projections 1 and 2, respectively, are in each case subjected individually to mathematical analysis. After location of a point adjacent to the seed point 5, the procedure is repeated for points in turn adjacent to this point, until the entire structure of the blood vessel 3 has been reconstructed within the volume 4.

The point investigated in each case with each propagation step is identified as belonging to the blood vessel if the mathematical analysis of the local areas 6 and 7 gives a positive result for all or the majority of the projections belonging to the projection data set (i.e., in this example projections 1 and 2, respectively). The local areas 6 and 7 are determined by projecting the point 5, in accordance with the projection directions in which the two projections 1 and 2 were recorded, into the corresponding planes of these two projections. This is indicated in FIG. 1 by arrows 8 and 9, respectively. Note the while this known 3D front propagation method has been described with respect to two (2) projections of the same heart phase, it is not limited to two (2) projections.

Accordingly, an improved method and system for overcoming the problems in the art is desired.

According to an embodiment of the present disclosure, a method for computer-aided automatic four-dimensional (4D) modeling of an anatomical object comprises acquiring automatically a set of three-dimensional (3D) models representing a plurality of static states of the object throughout a cycle. A 4D correspondency estimation is performed on the set of 3D models to determine which points of the 3D models most likely correspond to each other, wherein the 4D correspondency estimation includes one or more of (i) defining a reference phase, (ii) performing vessel-oriented correspondency estimation, and (iii) post-processing of 4D motion data. The method can also be implemented by an imaging system, as well as in the form of a computer program product. Furthermore, the method according to one embodiment of the present disclosure also includes enabling automatic 3D modeling with a front propagation algorithm.

FIG. 1 shows schematically a diagnostic projection data set consisting of two (2) two-dimensional (2D) projection images;

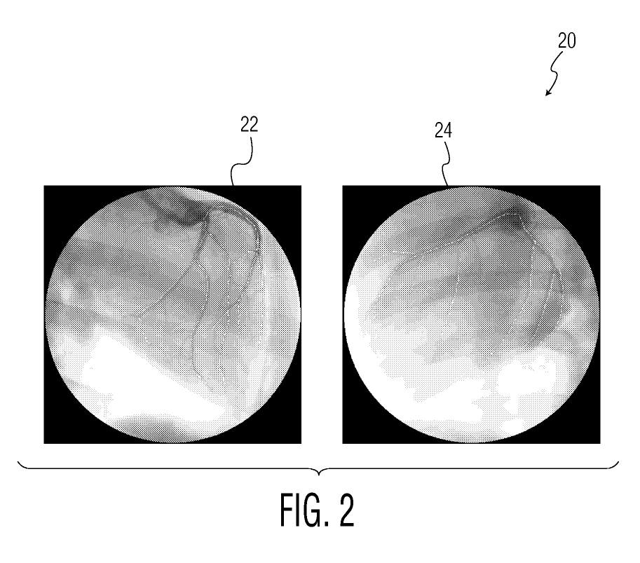

FIG. 2 is an example of fully automatically extracted 3D centerlines back-projected into two projection images of an underlying cardiac phase, obtained with the modeling method according to one embodiment of the present disclosure;

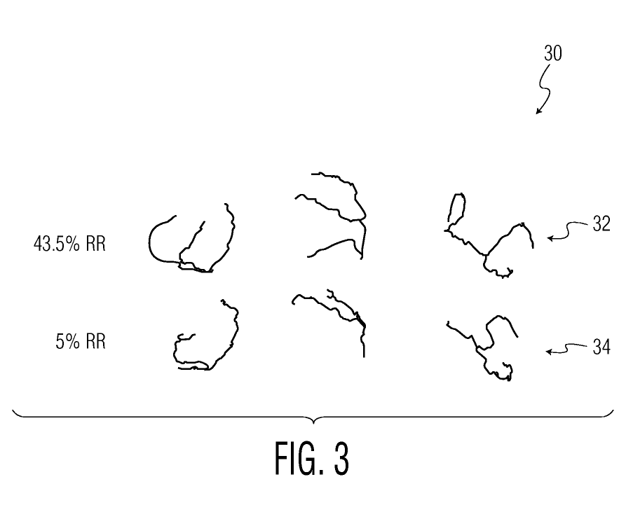

FIG. 3 is an illustrative view showing examples of projections along three orthogonal axes of extracted vessels at two different cardiac phases, obtained with the modeling method according to one embodiment of the present disclosure; and

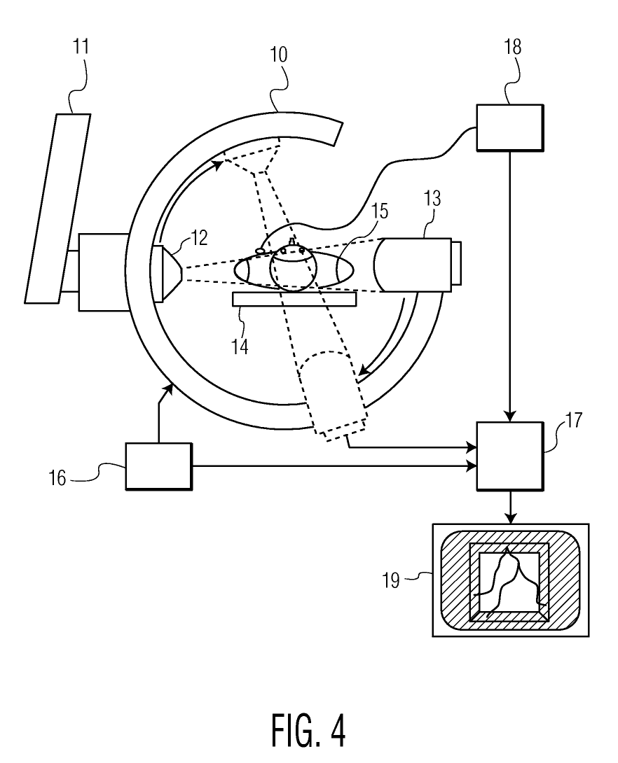

FIG. 4 is a partial block diagram view of an imaging apparatus according to another embodiment of the present disclosure.

In the figures, like reference numerals refer to like elements. In addition, it is to be noted that the figures may not be drawn to scale.

### Automatic 3D Modeling:

According to one embodiment of the present disclosure, a method comprises automatic 3D vessel centerline extraction from gated rotational angiography X-ray projections using a front propagation method. In particular, the method includes a non-interactive algorithm for the automatic extraction of coronary centerline trees from gated 3D rotational X-ray projections, i.e., without human interaction. The method utilizes the front propagation approach to select voxels that belong to coronary arteries. The front propagation speed is controlled by a 3D vesselness probability, which is defined by forward projecting the considered voxel into every vesselness-filtered projection of the same cardiac phase, picking the 2D response pixel values and combining them. The method further includes different ways of combining 2D response values to a 3D vesselness probability. The method still further includes utilizing several single-phase models to build a combined multi-phase model.

Stated another way, the method includes a fully automatic algorithm for the extraction of coronary centerline trees from gated 3D rotational X-ray projections. The algorithm is feasible when using good quality projections at the end-diastolic cardiac phase. Shortcut-artifacts from almost kissing vessels in systolic phases and ghost vessel artifacts can be significantly reduced by use of alternative versions of the front propagation algorithm. All algorithm versions have limited motion compensation ability, thus after finding an optimal cardiac phase, centerline extraction of projections with residual respiratory motion is possible. In addition, single-phase models can also be combined in order to determine the best cardiac phase and to reduce the probability of incorrectly traced vessels. Furthermore, corresponding points in different single-phase models can be found in order to generate a full 4D coronary motion field with this approach.

Accordingly, the front propagation methods as discussed herein enable automatic extraction of a coronary vessel centerline tree without human interaction. Further as noted above, the front propagation models are relatively insensitive to residual motion, especially caused by respiration. According to one embodiment, it is necessary to determine a model that represents the coronary vessel shape at the cardiac phase of least motion from a set of ECG gated models. In the centerline extraction algorithm, the algorithm enables a fully automatic coronary vessel centerline extraction based on the front propagation approach.

As discussed herein, the automatic 3D front propagation algorithm uses gated projections as input. The gating is performed according to a simultaneously recorded electrocardiogram (ECG) signal. The algorithm consists of multiple preparation and analysis steps, including (i) prefiltering of the gated projections; (ii) finding seed point, (iii) front propagation; (iv) for all vessel candidates: (a) finding end points, (b) backtracing, and (c) cropping and structuring; (v) finding the “root arc”; (vi) linking; (vii) weighting; and (viii) output and linking for output.

Prefiltering of the Gated Projections

In a first step, the projections are sorted into groups of same delay with respect to the R-peak of the ECG signal. A gated projection data set consists of the nearest neighbor projections to a given gating point from every heart cycle. All following steps of the algorithm are carried out on gated projection sets. In the next step, the projections are filtered using a multiscale vesselness filter, with filter widths from 1 to 7 pixels. The result is a set of 2D response matrices R^{2D}, which provide a probability for each pixel to belong to a vessel or not. The multiscale vesselness filter is defined as the maximum of the eigenvalues of the hessian matrices of all scales. To avoid border artifacts, the vessel-filtered projections can be cropped by a circular mask with a radius of about (0.98* projection width).

### Finding Seed Point

For each voxel \vec{x^{3D}}, a corresponding pixel on each projection can be calculated by using a cone-beam forward projection. The cone-beam forward projection can be characterized where n denotes the current projection, \vec{e_{n,x}}, \vec{e_{n,y}}, and \vec{e_{n,z}}, are the normal vectors of the detector plane, \vec{Dₙ} is the detector origin, \vec{Fₙ} the focus point, defining the trajectory data for each projection. \vec{x^{3D}} is the considered voxel and \vec{Pₙ}, its projection. The dimensions of the detector plane are determined by wₓ and w_{y} (width and height in mm) and pₓ and p_{y} (width and height in pixels).

The projected pixel on the detector plane in 3D is computed as follows:

$${{P}^{->}}_{n} = ( \frac{( {{D}^{->}}_{n} - {{F}^{->}}_{n} ) \cdot {{e}_{n , z}}^{->}}{( {{x}^{3 D}}^{->} - {{F}^{->}}_{n} ) \cdot {{e}_{n , z}}^{->}} ) \cdot ( {{x}^{3 D}}^{->} - {{F}^{->}}_{n} ) + {{F}^{->}}_{n} . \qquad ( Eq . 1 )$$

Then the corresponding (x,y)-coordinates on a projection are:

$${v}_{n , x / y} = ( {{P}^{->}}_{n} - {{D}^{->}}_{n} ) \cdot {{e}^{->}}_{n , x / y} \cdot \frac{{p}_{x / y}}{{w}_{x / y}} . \qquad ( Eq . 2 )$$

Because the system geometry data is specific for each projection, the pixel coordinates v also depend on the current projection n.

Assuming there is no motion between different projections, the probability R^{3D} of a voxel \vec{x^{3D}} to be located within a vessel can be obtained by multiplying the 2D vesselness result values R^{2D} for all corresponding pixels:

$${R}^{3 D} ( {{x}^{3 D}}^{->} ) = {\prod }_{n = 0}^{N} {R}^{2 D} ( {{v}_{n}}^{->} ( {{x}^{3 D}}^{->} ) ) . \qquad ( Eq . 3 )$$

A seed point is consequently found by choosing the voxel with the largest response within a certain subvolume.

Currently, a subvolume of about 11% of the whole volume is examined this way, because the main vessels (ideally the root arc) are assumed to be located within the cranial half of the volume and in the centre, so the subvolume is determined as follows:

0.25·xₘₐₓ≦x<0.75·xₘₐₓ

0.25·zₘₐₓ≦z<0.75·zₘₐₓ

0.5·yₘₐₓ≦y≦0.95·yₘₐₓ (Eq. 4)

where the y-axis is oriented in caudo-cranial direction. The maximum y value should not reach yₘₐₓ, because residual border artifacts of the vessel-filtered projections may affect the search for an appropriate seed point.

For further acceleration, the 3D response value for each voxel is not completely calculated using all N projections. If, after calculating the product of n projections, the intermediate value falls below the currently highest response value, the remaining N-n projections don't need to be calculated, because with every additional multiplication, the intermediate response value can only decrease further. This results in an additional acceleration factor of 2 to 5 depending on the source data.

Front Propagation

After an appropriate seedpoint has been found, the front propagation can be started. For each voxel that has been examined before, a characteristic value will be stored, which indicates how “quickly” the front has propagated towards this voxel starting from the seed point. Consequently, this value is called time value and set to zero at the seed point. The increase of these time values following an arbitrary path should therefore be lower for probably good vessels and higher (steeper) for “bad” vessels and artifacts.

At each iteration step, starting from the voxel on the front with the currently lowest time value, the 3D vessel response values of every neighboring voxel is calculated, and its reciprocal is added to the time value of the considered start voxel. If a neighbouring voxel has been considered before, it's value won't be recalculated again. Thus, the time value T(\vec{x^{3D}}(λ₀)) for a voxel \vec{x^{3D}}(λ₀) reached after λ₀ steps, represents the history of the best possible path beginning at the seed point, because it contains the response values of all preceding voxels:

$$T ( {{x}^{3 D}}^{->} ( {λ}_{0} ) ) = {\sum }_{λ = 1}^{{λ}_{0}} {( {R}^{3 D} ( {{x}^{3 D}}^{->} ( λ ) ) )}^{- 1} . \qquad ( Eq . 5 )$$

There are several ways to compute an appropriate response value R^{3D} for each voxel. The overall quality of the algorithm mainly depends on the quality of the approach used here. Thus, different approaches have been tried out, but only three of them proved to be feasible.

First Front Propagation Approach (FP1)

A simple and stable way is to multiply all response values of the corresponding pixels on each filtered projection:

$${R}^{3 D} ( {{x}^{3 D}}^{->} ) = {\prod }_{n = 0}^{N} {R}^{2 D} ( {{v}_{n}}^{->} ( {{x}^{3 D}}^{->} ) ) , \qquad ( Eq . 6 )$$

where n covers the gated projections and R^{2D} is the corresponding pixel value on the current filtered projection, whose coordinates are given by \vec{vₙ} as mentioned herein above. Thus, R^{3D} is higher for better response and vice versa. The multiplication is practically no problem with very low R^{2D} responses, because even apart from vessel structures, the R^{2D} response does not actually reach zero.

This approach gives reasonable results if the vessels on almost all projections of the set are of similar and relatively high quality. It has problems to trace weak and thin vessels, consequently even larger vessels might not be traced until their actual ending, as they are getting finer. The front propagates quickly towards the “good” vessels, but as they are getting weaker, the front progress becomes more and more indifferent and tends to propagate towards the border of the vessels. Therefore, reasonable tracing of the whole vessel tree using relatively poor-quality projections will consume much computing power by doing many iterations (e.g., about 3-5 million for 512³ resolution). Nevertheless, the outer ends of the vessels might still not be traced completely.

Second Front Propagation Approach (FP2)

A solution for the problem of tracing thin vessels as described in the preceding section might be to prefer voxels with low response to those that are obviously not lying on a vessel at all. The second front propagation approach therefore tries to emphasize voxels with a relatively even response on all projections compared to those whose response values of the backprojected pixels differ more. This decision may be wrong, because even “correct” voxels might have bad response values on some projections because of movement or bad projection/prefiltering quality. Because every filtered projection is normalized to 1, the result can be emphasized by raising it to a power below 1 and suppressed by raising it to a power above 1. In order to describe how uniformly the 2D response values of a certain voxel \vec{x^{3D}} are distributed, the exponent η(\vec{x^{3D}}) is now calculated as normalized variance:

$$\begin{matrix}η ( {{x}^{3 D}}^{->} ) = \frac{{\sum }_{m = 1}^{N} \vert {R}^{2 D} ( {{v}_{m}}^{->} ( {{x}^{3 D}}^{->} ) ) - {{R}_{n}^{2 D}}^{->} \vert}{N \cdot {( {{R}_{n}^{2 D}}^{->} )}^{2}} , with & ( Eq . 7 ) \\ \overline{{R}_{n}^{2 D}} = \frac{{\sum }_{n = 1}^{N} {R}^{2 D} ( {{v}_{n}}^{->} ( {{x}^{3 D}}^{->} ) )}{N} , & ( Eq . 8 )\end{matrix}$$

and used as follows:

$${R}^{3 D} ( {{x}^{3 D}}^{->} ) = {\prod }_{n = 0}^{N} {{R}^{2 D} ( {{v}_{n}}^{->} ( {{x}^{3 D}}^{->} ) )}^{η ( {{x}^{3 D}}^{->} )} . \qquad ( Eq . 9 )$$

This approach prefers weak vessels but will decrease the motion compensation ability. It tends to be unstable in some cases.

Third Front Propagation Approach (FP3)

A third front propagation approach is to account for the projection angle difference αₘ-αₙ between two projections m and n to prefer information extracted from perpendicular views to those taken from views of similar angle. This should minimize misinterpretations of depth information within two projections. Because there are more than two projections available, all projections (1 . . . n₀) are considered by pairs and the respective results are combined by multiplication. The response value for each pair of projections is calculated by multiplying their according 2D response values and weighting them by the sine of projection difference angle:

$${R}^{3 D} ( {{x}^{3 D}}^{->} ) = {\prod }_{m = 0}^{N - 1} {\prod }_{n = m + 1}^{N} \vert sin ( {α}_{m} - {α}_{n} ) \vert \cdot {R}^{2 D} ( {{v}_{n}}^{->} ( {{x}^{3 D}}^{->} ) ) \cdot {R}^{2 D} ( {{v}^{->}}_{m} ( {{x}^{3 D}}^{->} ) ) . \qquad ( Eq . 10 )$$

The sine is obtained by calculating the cross product of the vectors pointing from the volume centre M to the detector D divided by their respective length:

$$sin ( {α}_{m} - {α}_{n} ) = \frac{\vert ( {{D}_{m}}^{->} - {M}^{->} ) \times ( {{D}_{n}}^{->} - {M}^{->} ) \vert}{\vert {{D}_{m}}^{->} - {M}^{->} \vert \cdot \vert {{D}_{n}}^{->} - {M}^{->} \vert} . \qquad ( Eq . 11 )$$

This third front propagation approach performs well when tracing thin vessels and compensates residual motion. In addition, the third front propagation approach may be more stable than the second front propagation approach.

Terminating the Front Propagation

Depending on the volume resolution and the quality of the projections, there is a rule-of-thumb value of the number of iterations that are reasonable:

i_{0,FP1}≈0.03·number of voxels. (Eq. 12)

With respect to the first front propagation, for 256³ voxels, about 500 k iterations are sufficient, while 512³ will need about 4,000 k iterations to let the front propagate into similar regions. However, the later number of iterations consumes about eight (8) times more memory and computation time. The second and third FP approach only need about half as many iterations to get similar results.

Finding Vessel Segments

After finding an end point, the vessel centerline is traced, cropped and its parts are stored separately. Consecutive vessels are treated the same way. The following three steps of (1) finding end points, (2) backtracing, and (3) cropping and structuring are therefore done for each vessel candidate and its subvessels respectively.

(1) Finding End Points

After the front propagation has finished, for every vessel an appropriate end point has to be found. This is achieved by dividing the whole volume into n³ subvolumes where n=50 at this stage. Within each volume, the voxel with the highest time values is chosen. This voxel is located on the outer edge of a vessel, because the front is propagating quickly at the centre of each vessel and then broadens slowly (causing high time values) towards its border.

(2) Backtracing

The backtracing is performed using a steepest gradient method. Given an end point, the backtracing is directed towards the voxel with the largest time value decrease with respect to the current one. By following the largest decrease at every step, an optimal path back to the seed point is calculated. Starting at the surface of the front propagation, it leads directly to the vessel center and then along the centerline to the seed point. If a path has already been traced before by an earlier iteration, it will not be traced again. This is managed by a 3D bitmap in which the traced voxels are marked plus an additional safety area of two voxels at each side. This prevents doubled tracing of similar (parallel) paths.

(3) Cropping and Structuring

It is noted that voxels located at the border of a vessel do not belong to the centerline and thus such voxels need to be cropped. Cropping is done by a recursive algorithm, wherein the recursive algorithm's task is to split the traced centerline into segments of different quality. The segment at the point where backtracing has begun, has worst quality and is thereby eliminated.

The recursive cropping algorithm assumes that the quality of every vessel is best close to the seed point and decreases towards its backtracing start point. The mean value of the first quarter of the current vessel voxels is calculated, wherein the calculated value is then used as threshold while scanning towards the tracing start point. The threshold may be occasionally exceeded several times, but if the number of those exceeding gets beyond a tolerance value (for example, a maximum of ten (10) consecutive times), then the particular spot is considered a significant quality breach and the vessel is split into two parts. This means, the worst quality segments are cut away from the vessel segment of better quality and then stored as an independent vessel. This second vessel is then treated the same way, thus the segment for the independent vessel is separated and so on. The recursive algorithm is aborted if the remaining part is shorter than a minimal length (for example, on the order of ten (10) voxels). The border voxels located at the tracing start point are either cut away by the minimum length criterion or, if their length exceeds ten (10) voxels, then they are rated negligible by the weighting algorithm discussed later herein.

Finding the “Root Arc”

As mentioned herein, the seed point for the front propagation does not necessarily correspond to the root arc, which is the inflow node of the coronary artery tree. As a consequence, every vessel is traced back to this “wrong” starting point. To estimate the real position of the root arc, the most cranial point of the longest three single vessels segments is used. The linking vessel segment between the seed point and the new top point is then used to extend other vessels, if necessary.

Linking

Up to now, the vessels have no relation to each other. Each vessel ending is caused by one of the following three reasons: i) the root arc has been reached, thus no linking is needed; ii) the vessel was formerly a part of a longer vessel and has been separated by the cropping and structuring algorithm described herein above; and iii) there is a bifurcation, which means that there is another vessel crossing, which has been detected at backtracing stage. Up to this point, it is only known whether a path has been traced before, but not which vessel uses it. The correct successor vessel is determined by choosing the point that is geometrically closest to the end point of every vessel segment. Because at the backtracing stage all vessels were indexed in an ascending order, it is only necessary to search for points on vessels of a lower index than the considered one. After linking, the total length of every vessel (from end point to root arc) can easily be calculated by adding the length of all vessel segments along a link path.

Weighting

In the steps described herein above, a large number of paths have been extracted, but only a few of them really represent existing vessels, while the majority are caused by artifacts such as lack of projection quality, residual motion, foreshortening etc. Therefore, it must be determined, which of them most probably represent real vessels. A measure S for the overall significance of an extracted path candidate can be composed of several factors: i) length of vessel segment or total length, ii) quality, determined by time values, iii) 3D position (probably with the assistance of a pre-defined model), and (iv) shape. According to the significance value S, all path candidates can be sorted, which enables one to choose the most significant path for output, where the maximum number of paths to output can be set by a system user. The calculation of the significance value S is still to improve, because a misjudgement here can lead to the output of a wrong (“ghost”) vessel. In one embodiment, S is calculated as follows:

$$S = \vert {y}_{end} - {y}_{root\_arc} \vert \cdot \frac{{l}_{part}^{2}}{T ( {{x}^{3 D}}^{->} ( {λ}_{end} ) )} , \qquad ( Eq . 13 )$$

where y_{end} and yᵣₒₒₜ_{_{—}}_{arc} are the y coordinates (along the caudo-cranial rotational axis) of the current vessel segment end point and of the root arc determined as described herein above, respectively. The quantity lₚₐᵣₜ is the length of the vessel segment in voxels and T(\vec{x^{3D}}(λ_{end})) is the time value of the end point of the vessel segment. It may be possible to automatically estimate a reasonable number of extractable vessel centerlines using, for example, gradient criteria.

Output and Linking for Output

When saving the centerline data into a file, it may be necessary to check the links and to re-link some parts of the vessels, because one or more segments of a linked path may not be selected for output.

According to an embodiment of the present disclosure, an improved front propagation algorithm transforms the prior known method of a semi-automatic 3D algorithm into a fully automatic 4D algorithm. The method addresses various problems discussed herein above and provides solutions as follows:

1. Seed point: According to one embodiment, the seed point is defined automatically by evaluating the above mentioned 3D vessel response in a centered cranial sub-volume of the 3D volume observable in every angiogram, and selecting the point with a maximum 3D response. Any suitable type of cardiac phase monitoring can be used in parallel with acquisition of the X-ray projections of a corresponding 3D response, for example, the cardiac phase monitoring may include the recording of an electrocardiogram (ECG). The maximum 3D response point is located on the vessel tree, but not necessarily at the inflow node of the main bifurcation. An alternative method is to select the point with maximum 3D response on the cranial part of the surface of the above mentioned volume. In the later instance, this provides a seed point located on the catheter filled with contrast agent, which comes in from the cranial side via the aorta.

2. Stopping the front propagation: The number of performed iterations of the front propagation is derived from either (i) the voxel resolution of the front propagation volume or (ii) by analysing the decrease of the 3D response values along an extracted vessel.

3. End Points: Potential end points of vessels can be determined automatically by one or more different methods. In a first embodiment, the front propagation volume is divided into a large number of sub-volumes (e.g. 50³ or 50*50*50). Within every sub-volume, the point with the latest front arrival is selected as the start point for a back tracing algorithm. The back tracing algorithm follows a speed field backwards along the path with the steepest gradient to the seed point. In a second embodiment, during a front propagation, the algorithm tracks the path along the steepest gradient and stops if a major decrease of the 3D vessel response is detected. In any event, the accurate estimation of potential vessel end points is not extremely critical, because in the following structuring step, the vessel-segments are analysed and weighted according to their relevance.

4. Structuring: The vessels are divided into different segments by a dynamic structuring algorithm. The dynamic structuring algorithm determines sections of the extracted centrelines with homogenous 3D vessel response. A weighting of each vessel-segment is performed according to different criteria: (i) length, (ii) 3D vessel response (corresponding to quality), (iii) shape and position of the centreline (or optionally based on an a-priori coronary model). The most relevant weighted vessels are automatically selected and constitute the output of the 3D algorithm. FIG. 2 contains examples (20) of fully automatically extracted 3D centerlines back-projected into two projections (22 and 24) of an underlying cardiac phase, obtained with the modeling method according to one embodiment of the present disclosure.

4D Algorithm:

According to one embodiment of the present disclosure, the automatic 4D coronary modeling and motion vector field estimation method needs at input a set of 3D models representing all static states throughout the whole cardiac cycle by repeating the above described procedure for every distinguishable cardiac phase. The method determines corresponding points of different models by matching bifurcations and other shape properties of the different models. A possible application in which to exploit the 4D information is to derive an optimal cardiac phase for gated or motion-compensated 3D reconstruction.

The method according to the embodiments of the present disclosure provides a fully automatic, robust 4D algorithm for coronary centreline extraction and modeling. The method is capable to handle inconsistencies in angiograms of the same heart phase due to residual motion. Furthermore, the method according to the embodiments of the present disclosure provides improvements over the prior known 3D front propagation algorithm, wherein the improvements enable new applications such as 4D motion compensated reconstructions and modeling.

A set of 3D models representing all static states throughout the whole cardiac cycle can be obtained by repeating the 3D modeling procedure for every distinguishable cardiac phase. Depending on the minimum heart beat rate during the rotational run f_{h,min} (in beats per minute, bpm) and the acquisition frame rate fₐ(in 1/s), the number of distinguishable cardiac phases p_{N} equals to:

$$PN = 60 \frac{s}{min} \cdot \frac{fa}{{f}_{h , min}} ,$$

which means that p_{N} independent 3D models have been created. This value ranges from about 15 for an acquisition frame rate fₐ of 25 fps (frames per second) and heart beat rate fₕ of 100 bpm (beats per minute) to about 40 for fₐ 30 fps and fₕ 45 bpm. The task of 4D correspondency estimation is to determine which points of the models most likely correspond to each other, which enables to estimate the motion of certain part of the vessel tree throughout the cardiac cycle. Problems like longitudinal motion of the vessels and ambiguities caused during the 3D modeling process, which make 4D correspondency estimation more difficult, have to be taken into consideration. The correspondency estimation is performed by executing the following steps:

1. Definition of reference phase (stable phase)

2. Vessel-oriented correspondency estimation

3. Post-processing of 4D motion data

1. Definition of Reference Phase

To estimate stable 4D correspondencies, it is necessary to decide which of the many potential vessels structures extracted during the steps are of highest significance during the whole cardiac cycle. During the 3D algorithm, the vessel segments are weighted according to their presumed significance, but this is done independently for every single 3D model, which results in fluctuation of the extracted vessels at different cardiac phases. Therefore, a reference phase pᵣ (stable phase) with all desired vessels extracted must be defined prior to the correspondency estimation. This can either be done automatically or manually.

Automatic definition: Either, the 3D model representing the phase nearest to 35% RR is chosen, which is in practice very likely a phase of low motion and consequently phase of good extraction quality or the model containing the three longest vessels is chosen. Note that RR represents a time interval defined by two subsequent R-peaks of an ECG, wherein the ECG is dominated by R-peaks and each R-peak represents an electrical impulse which precedes the contraction of the heart.

Manual definition: According to visual inspection of all extracted 3D models (e.g. using an overview plot 30 with projections of all models as shown in FIG. 3), one can manually define the most suitable cardiac phase and restart the algorithm. FIG. 3 shows an example 30 of two projections of extracted vessels at different cardiac phases. The upper row 32, representing cardiac phase of 43.5% RR, shows three correctly extracted vessels which qualifies that phase as potential reference phase, while the quality of the vessels shown in the bottom row 34 (5% RR) is worse.

2.Vessel-Oriented Correspondency Estimation

The correspondence estimation is performed independently for every extracted vessel at the reference phase pᵣ using one stable point at each model. When performing this step for the first time, the main bifurcation (“root arc”) serves as stable point while during later iterations, sub-bifurcation points with probably higher precision are used. The algorithm exploits the fact that, during a cardiac cycle, the vessel's arc length λ does not change considerably (less than 2% in total). The 3D coordinates:

\vec{x^{3D}}=\vec{x^{3D}}(λ)

of any vessel point are parameterized by the vessel's arc length λ, which depends on the considered phase number p, the considered vessel number v and the voxel number i along the vessel path: λ=λ(p, v, i). If, in the following, the text refers to entire vessel, the voxel number i is omitted.

Equally spaced versions of both the currently considered reference phase vessel λ (pᵣ, vᵣ) and the current target phase vessel λ(p, v), maintaining a predefined spacing s (currently set to 2 mm), are created, because the point-to-point distances of the original 3D models vary by factor of √3 and more, caused by diagonal voxel distances and linking gaps. They represent the whole path from the stable point to the vessel's end. The vessel point coordinates are low-pass filtered prior to the equidistant spacing to eliminate quantization effects originating from the voxel representation of the front propagation and thus to provide a stable arc length criterion. The low-pass version of the vessel λ(p, v) is denoted by λ′(p, v). The two vessels are compared point by point and an overall similarity criterion C is computed:

$$\begin{matrix}C ( {v}_{r} , v ) = \frac{{\sum }_{i = 0}^{{i}_{max} - 1} ∈ \cdot \vert {{x}^{3 D}}^{->} ( {λ}^{′} ( {p}_{r} , {v}_{r} , i ) ) - {{x}^{3 D}}^{->} ( {λ}^{′} ( p , v , i ) ) \vert}{{i}_{max}^{2} \cdot {\sum }_{i = 0}^{{i}_{max} - 1} ∈} \\ {i}_{max} = min [ {λ}^{′} ( pr , vr , end ) , {λ}^{′} ( p , v , end ) ] , \\ ∈ = i + 1\end{matrix}$$

Smaller similarity criteria C indicate better correspondence between the two current vessels. Consequently, the vessel combination with smallest C is considered to be equivalent. This procedure is repeated for every combination of source vessels vᵣ and target phase vessels v and every possible target phase p≠pᵣ. All corresponding coordinates of the corresponding vessels are finally stored in a dynamic array A(p,i) (called motion field) with indices [0 . . . p_{N-1}] (phase) and [0 . . . iₘₐₓ₋₁] (corresponding 3D points).

3. Post-Processing of 4D Motion Data

During the correspondency estimation procedure every corresponding vessel is represented beginning from the reference point (normally the root arc), which causes several parts of the vessel tree to be represented multiple times. This results in high local point densities, which need to be thinned out to avoid singularities and other ambiguities. The reduction is achieved by computing the Euclidean distance d between each combination of points belonging to a certain phase and erasing one of them if the distance falls below a threshold, which is defined as t=0.5 s=1 mm

$$d ( p , {i}_{1} , {i}_{2} ) = \vert {A}^{->} ( p , {i}_{1} ) - {A}^{->} ( p , {i}_{2} ) \vert .$$

The resulting corresponding “root arc” points throughout all cardiac cycles can be checked for outliers. If the distance of the root arc in a specific phase to the median (or mean) position is above a given threshold, this cardiac phase is excluded from the model. In a similar manner all other bifurcation and single points can be treated.

Turning now to FIG. 4, the imaging apparatus illustrated therein is a C-arm X-ray apparatus, which comprises a C-arm 10, which is suspended by means of a holder 11, for example, from a ceiling (not shown). An X-ray source 12 and an X-ray image converter 13 are guided movably on the C-arm 10, such that a plurality of two-dimensional projection X-ray images of a patient 15 lying on a table 14 in the center of the C-arm 10 may be recorded at different projection angles. Synchronous movement of the X-ray source 12 and the X-ray image converter 13 is controlled by a control unit 16. During image recording, the X-ray source 12 and the X-ray image converter 13 travel synchronously around the patient 15. The image signals generated by the X-ray image converter 13 are transmitted to a controlled image processing unit 17. The heart beat of the patient 15 is monitored using an ECG apparatus 18. The ECG apparatus 18 transmits control signals to the image processing unit 17, such that the latter is in a position to store a plurality of two-dimensional projections in each case in the same phase of the heart beat cycle to perform an angiographic investigation of the coronary arteries. The image processing unit 17 comprises a program control, by means of which three-dimensional models of a blood vessel tree detected with the projection data set thus acquired can be performed, according to a 3D front propagation method. In addition, the image processing unit 17 comprises a further program control, by means of which 4D modeling can be performed, according to the embodiments of the present disclosure. The 4D modeling, as well as one or more reconstructed blood vessel, may then be visualized in any suitable manner on a monitor 19 connected to the image processing unit 17.

Although only a few exemplary embodiments have been described in detail above, those skilled in the art will readily appreciate that many modifications are possible in the exemplary embodiments without materially departing from the novel teachings and advantages of the embodiments of the present disclosure. For example, the embodiments of the present disclosure can be applied to other periodically moving structures such as cardiac venes or more general to tree-like structures. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

In addition, any reference signs placed in parentheses in one or more claims shall not be construed as limiting the claims. The word “comprising” and “comprises,” and the like, does not exclude the presence of elements or steps other than those listed in any claim or the specification as a whole. The singular reference of an element does not exclude the plural references of such elements and vice-versa. One or more of the embodiments may be implemented by means of hardware comprising several distinct elements, and/or by means of a suitably programmed computer. In a device claim enumerating several means, several of these means may be embodied by one and the same item of hardware. The mere fact that certain measures are recited in mutually different dependent claims does not indicate that a combination of these measures cannot be used to an advantage.

1. A method of computer-aided modeling of an anatomical object comprising:
acquiring gated rotational X-ray projections of the anatomical object; and
automatically extracting three-dimensional (3D) vessel centerlines from the gated rotational X-ray projections using a front propagation method, wherein the front propagation method comprises automatically finding points in different ones of single-phase front propagations.

2. The method of claim 1, wherein responsive to finding corresponding points in the different ones of the single-phase front propagations, a four-dimensional (4D) coronary motion field can be generated as a function of the corresponding points.

3. The method of claim 1, wherein automatically extracting 3D vessel centerlines comprises one or more of:
(i) prefiltering the gated rotational X-ray projections, wherein prefiltering includes sorting the gated projections into data sets, wherein the gated projection data sets comprise nearest neighbor projections to a given gating point from every heart cycle;
(ii) finding a seed point, wherein the seed point comprises a voxel having a largest 3D vessel response within a given subvolume;
(iii) performing a front propagation, wherein a number of performed iterations of the front propagation is derived from either (a) a voxel resolution of a front propagation volume or (b) by analyzing a decrease in three-dimensional (3D) responses along an extracted vessel candidate;
(iv) performing for the extracted vessel candidates and corresponding sub-vessels: (a) finding vessel end points, (b) back tracing a vessel centerline along a path with a steepest gradient to the seed point, and (c) cropping and structuring, wherein the cropping and structuring divide the vessel into different segments, and further determines sections of the extracted centerlines with homogenous 3D vessel response;
(v) finding a root arc, the root arc corresponding to an inflow node of a coronary artery tree;
(vi) linking related vessel segments to one another, wherein a corresponding successor vessel segment is determined by choosing a point that is geometrically closest to the end point of a given vessel segment; and
(vii) weighting vessel segments, wherein weighting of each vessel-segment is performed according to one or more different criteria including (a) length of a vessel segment, (b) 3D vessel response, (c) and shape and position of the centerline.

4. The method of claim 3, further wherein the projection data sets are of a same delay with respect to the R-peak of an ECG signal.

5. The method of claim 3, wherein prefiltering further comprises filtering the gated rotational X-ray projections using a multiscale vesselness filter, the multiscale vesselness filter being defined as the maximum of the eigenvalues of the Hessian matrices of all scales.

6. The method of claim 3, wherein prefiltering further includes cropping the projection data sets with a circular mask having a radius of about ninety-eight percent (98%) of the projection data set width.

7. The method of claim 1, wherein gating of the gated rotational X-ray projections is performed according to a simultaneously recorded electrocardiogram (ECG) signal.

8. The method of claim 1, further comprising:
prefiltering the gated rotational X-ray projections, wherein the projections are sorted into groups of same delay with respect to an R-peak of an ECG signal.

9. The method of claim 1, further comprising:
determining an optimal cardiac phase from the gated rotational Xray projections with residual respiratory motion; and
automatically extracting three-dimensional (3D) vessel centerlines from the gated rotational X-ray projections using the front propagation method, further as a function of the optimal cardiac phase.

10. The method of claim 1, further comprising:
controlling a speed of the front propagation method with the use of a 3D vesselness probability.

11. The method of claim 10, wherein the 3D vesselness probability is defined by forward projecting a considered voxel into every vesselness-filtered projection of the same cardiac phase, selecting two-dimensional (2D) response pixel values and combining the 2D response pixel values to the 3D vesselness probability.

12. The method of claim 1, wherein the front propagation selects voxels that belong to coronary arteries.

13. The method of claim 1, wherein the front propagation model utilizes more than one single-phase front propagation to build a combined multi-phase front propagation.

14. The method of claim 1, further comprising:
finding corresponding points in different ones of the single-phase front propagations; and
generating a four-dimensional (4D) coronary motion field as a function of the corresponding points in the different single-phase front propagations.

15. An imaging apparatus comprising:
means for generating a projection data set, which set comprises a plurality rotational X-ray projections of a body part of a patient recorded from different projection directions, and having computer means for reconstructing a three-dimensional object from the projection data set, wherein the computer means comprises a computer control which operates to perform computer-aided modeling of the object according to the method of claim 1.

16. The imaging apparatus of claim 15, further comprising an ECG control in which recording of rotational X-ray projections can be controlled in accordance with the cardiac cycle of the patient.

17. A computer program product comprising:
computer readable media having a set of instructions that are executable by a computer for performing computer-aided modeling of an object according to the method of claim 1.

18. A method for computer-aided four-dimensional (4D) modeling of an anatomical object comprising:
acquiring a set of three-dimensional (3D) models representing a plurality of static states of the object throughout a cycle; and
performing a 4D correspondency estimation on the set of 3D models to determine which points of the 3D models most likely correspond to each other, wherein the 4D correspondency estimation includes one or more of (i) defining a reference phase, (ii) performing vessel-oriented correspondency estimation, and (iii) post-processing of 4D motion data.

19. The method of claim 18, wherein acquiring includes acquiring a set of 3D models representing all static states throughout a whole cardiac cycle.

20. The method of claim 18, wherein the cycle comprises a cardiac cycle, and wherein acquiring the set of 3D models further includes acquiring by repeating a 3D modeling procedure for a number of distinguishable cardiac phases of the cardiac cycle.

21. The method of claim 20, wherein the number of distinguishable cardiac phases depends on a minimum heart beat rate during a rotational run and an acquisition frame rate.

22. The method of claim 18, wherein the 4D correspondency estimation enables an estimating of motion of a certain part of a vessel tree throughout a cardiac cycle.

23. The method of claim 18, wherein the reference phase comprises a pre-defined stable phase that is defined prior to the vessel-oriented correspondency estimation.

24. The method of claim 18, wherein defining the reference phase comprises one of an automatic definition or a manual definition.

25. The method of claim 24, wherein the automatic definition chooses one of (i) a 3D model representing a desired phase nearest to a given percent RR in which the desired phase is of low motion, corresponding to a phase of good extraction quality or (ii) a 3D model containing three longest vessels.

26. The method of claim 24, wherein the manual definition includes: (i) visually inspecting extracted 3D models, (ii) manually defining a most suitable cardiac phase from the visually inspected 3D models, and (iii) starting the 4D corresponding estimation with the manual definition of reference phase.

27. The method of claim 18, wherein vessel-oriented correspondency estimation is performed independently for every extracted vessel at the reference phase using a stable point at each 3D model.

28. The method of claim 27, wherein for an initial vessel-oriented correspondency estimation, the stable point comprises a main bifurcation, and for one or more subsequent iterations of vessel-oriented correspondency estimation, the stable point comprises sub-bifurcation points.

29. The method of claim 27, wherein the vessel-oriented correspondency estimation (i) parameterizes 3D coordinates of any vessel point by the vessel's arc length λ, which depends on a considered phase number p, a considered vessel number v, and a voxel number i along the vessel path (ii) creates equally spaced versions of both a currently considered reference phase vessel and a current target vessel, maintained by a predefined spacing, (iii) performs low-pass filtering of vessel point coordinates to provide a stable arc length criterion, (iv) compares two vessels point by point, and (v) computes an overall similarity criterion as a function of the point by point comparison of the two vessels.

30. The method of claim 29, wherein the vessel-oriented correspondency estimation further comprises repeating steps (i)-(v) of the same for every combination of source vessels and target phase vessels and every possible target phase other than the reference phase, and still further comprises storing all corresponding coordinates of corresponding vessels in a dynamic motion field array with indices for phase and corresponding 3D points.

31. The method of claim 18, wherein post-processing of 4D motion data comprises checking points throughout the cardiac cycles for outliers, and responsive to finding a distance of a root arc point in a specific phase to a median position being above a given threshold, the post-processing of 4D motion data further comprises excluding the cardiac phase from 4D modeling.

32. The method of claim 18, wherein the post-processing of 4D motion data comprises computing a Euclidean distance d between each combination of points belonging to a certain phase and discarding one of them if the distance falls below a threshold.

33. An imaging apparatus comprising:
means for generating a projection data set, which set comprises a plurality of two-dimensional projections of a body part of a patient recorded from different projection directions, and having computer means for reconstructing a three-dimensional object from the projection data set, wherein the computer means comprises a computer control which operates to perform computer-aided four-dimensional modeling and motion compensated reconstructions of the object according to the method of claim 18.

34. The imaging apparatus of claim 33, further comprising an ECG control in which recording of two-dimensional projections can be controlled in accordance with the cardiac cycle of the patient.

35. A computer program product comprising:
computer readable media having a set of instructions that are executable by a computer for performing computer-aided four-dimensional modeling and motion compensated reconstructions of an object according to the method of claim 18.
